(19) United States
(12) Patent Application Publication
(10) Pub. No.: US 2018/0105055 A1
(43) Pub. Date: Apr. 19, 2018

(54) CHARGING CONTROL METHOD AND DEVICE AND CHARGING SYSTEM FOR ELECTRIC VEHICLE

(71) Applicant: Borgward Trademark Holdings GmbH, Stuttgart (DE)

(72) Inventors: Sujuan CHAI, Stuttgart (DE); Yanchao ZHANG, Stuttgart (DE)

(21) Appl. No.: 15/380,051

(22) Filed: Dec. 15, 2016

(30) Foreign Application Priority Data
Oct. 19, 2016 (DE) 102016220513.7

(51) Int. Cl. B60L 11/18; H02J 7/00

(52) U.S. Cl. CPC B60L 11/1838; H02J 7/0042; H02J 7/007; B60L 11/1818

(57) ABSTRACT

The present disclosure discloses a charging control method and device and an charging system for an electric vehicle. A method applied to a gun-shaped charging coupler comprises: detecting a press state of a latch button of the gun-shaped charging coupler; and sending a control signal to a charging pile connected with the gun-shaped charging coupler according to a detection result, the control signal being used for allowing the charging pile to obtain a charging control strategy, and controlling the charging pile to execute an operation corresponding to the charging control strategy. In such a way, when an electric vehicle is charged, the safety in the charging process can be improved with prolonging of the service lives of the gun-shaped charging coupler and a charging outlet and protection on the safety of people.

### RELATED APPLICATION DATA

The present application claims priority to German Patent Application No. 102016220513.7, filed Oct. 19, 2016, the disclosure of which is incorporated herein by reference in its entirety.

### FIELD OF THE INVENTION

The present disclosure relates to the field of electric vehicle charging, and specifically to a charging control method and device and a charging system for an electric vehicle.

### BACKGROUND OF THE INVENTION

With the popularization of electric vehicles, the charging safety of the electric vehicles have drawn more and more attentions. In an existing charging protection method, only a mechanical locking structure is used; then, when a user finds out that a charging card is forgotten at the moment of wanting to stop charging, the only way to end charging is directly pulling out a gun-shaped charging coupler. In this way, the gun-shaped charging coupler may have risks caused by being pulled out with load. As large-current charging is in progress at that time, sudden opening of a charging circuit may cause shortening of the service lives of the gun-shaped charging coupler and an electric vehicle charging outlet, and even worse, pose a threat to the safety of people.

### SUMMARY OF THE INVENTION

An objective of the present disclosure is to provide a charging control method and device and a charging system for an electric vehicle, thus improving safety during charging of an electric vehicle and avoiding both damage to a gun-shaped charging coupler and a vehicle charging outlet and harm to people.

To achieve the above objective, according to a first aspect of the present disclosure, a charging control method is provided, which is used for a gun-shaped charging coupler, and includes: detecting a press state of a latch button of the gun-shaped charging coupler; sending a control signal to a charging pile connected with the gun-shaped charging coupler according to a detection result, the control signal being used for allowing the charging pile to obtain a charging control strategy, and controlling the charging pile to execute an operation corresponding to the charging control strategy.

Optionally, the step of sending a control signal to the charging pile connected with the gun-shaped charging coupler according to the detection result includes: sending a control signal including the detection result to the charging pile connected with the gun-shaped charging coupler, the control signal being used for allowing the charging pile to obtain the charging control strategy according to the detection result.

Optionally, the control signal is further used for allowing the charging pile to determine an electronic lock control strategy for the gun-shaped charging coupler according to the detection result. The method further includes: receiving the electronic lock control strategy sent by the charging pile; and triggering the unlocking of the electronic lock when the electronic lock control strategy indicates unlocking of an electronic lock.

Optionally, the step of sending a control signal to the charging pile connected with the gun-shaped charging coupler according to the detection result includes: determining a charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery; and sending a control signal including the charging control strategy to the charging pile connected with the gun-shaped charging coupler.

Optionally, the method further includes: triggering the unlocking of the electronic lock in the gun-shaped charging coupler when the detection result indicates that the magnitude of the pressure on the latch button is greater than the preset third pressure threshold, and the duration of the pressure is greater than a third preset duration.

According to a second aspect of the present disclosure, a charging control method is provided, which is used for a charging pile, and includes: receiving a control signal sent by a gun-shaped charging coupler connected with the charging pile according to a detection result with respect to a press state of a latch button of the gun-shaped charging coupler; obtaining a charging control strategy according to the control signal; and executing an operation corresponding to the charging control strategy.

Optionally, the control signal includes a charging control strategy determined according to the detection result;

Optionally, the control signal includes the detection result, and the step of obtaining a charging control strategy according to the control signal includes: obtaining the detection result from the control signal; and determining the charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.

Optionally, the control signal includes the detection result. The method further includes: determining an electronic lock control strategy for the gun-shaped charging coupler according to the detection result, the electronic lock control strategy being used for indicating whether unlocking of an electronic lock is allowed, wherein when the detection result indicates that the magnitude of the pressure on the latch button is greater than the preset third pressure threshold, and the duration of the pressure is greater than a third preset duration, the electronic lock control strategy is determined as unlocking of the electronic lock; and sending the electronic lock control strategy to the gun-shaped charging coupler.

According to a third aspect of the present disclosure, a charging control device is provided, which is disposed in a gun-shaped charging coupler, and includes: a detection module configured to detect a press state of a latch button of the gun-shaped charging coupler, and a sending module configured to send a control signal to a charging pile connected with the gun-shaped charging coupler according to a detection result from the detection module, the control signal being used for allowing the charging pile to obtain a charging control strategy and controlling the charging pile to execute an operation corresponding to the charging control strategy.

Optionally, the sending module includes: a first sending submodule configured to send a control signal including the detection result to the charging pile connected with the gun-shaped charging coupler, the control signal being used for allowing the charging pile to obtain the charging control strategy according to the detection result.

Optionally, the sending module comprises: a first determination submodule configured to determine a charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery, and a second sending submodule configured to send a control signal including the charging control strategy to the charging pile connected with the gun-shaped charging coupler.

According to a fourth aspect of the present disclosure, a charging control device is provided, which is disposed in a charging pile, and includes:

a receiving module configured to receive a control signal sent by a gun-shaped charging coupler connected with the charging pile according to a detection result with respect to a press state of a latch button of the gun-shaped charging coupler, an obtaining module configured to obtain a charging control strategy according to the control signal, and an execution module configured to execute an operation corresponding to the charging control strategy.

Optionally, the control signal includes a charging control strategy determined according to the detection result.

Optionally, the control signal includes the detection result, and the obtaining module includes: an obtaining submodule configured to obtain the detection result from the control signal,

a second determination submodule configured to determine the charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.

According to a fifth aspect of the present disclosure, a charging system for an electric vehicle is provided. The system includes: a gun-shaped charging coupler configured with the charging control device provided according to the third aspect of the present disclosure, and a charging pile configured with a charging control device provided according to the fourth aspect of the present disclosure.

The above technical solutions can realize protection control in the process of charging an electric vehicle. A user can control charging, such as decreasing the charging current or stopping charging, by pressing the latch button on the gun-shaped charging coupler. In this way, when charging needs to be stopped and a user forgets a charging card, charging can be ended without pulling out the gun-shaped charging coupler, such that the risks caused by pulling out the gun-shaped charging coupler with load can be effectively avoided with guarantee on the service lives of the gun-shaped charging coupler and the vehicle charging outlet, protection on the safety of people, and improvement during charging of the electric vehicle.

Other features and advantages of the present disclosure will be described in detail in the subsequent part of detailed description of the embodiments.

### BRIEF DESCRIPTION OF THE DRAWINGS

Accompanying drawings are intended for providing further understanding and form part of the description to explain the present disclosure together with the following embodiments rather than limiting the present disclosure, in which:

FIG. 1 is a flow chart of a charging control method provided according to an embodiment of the present disclosure;

FIG. 2 is a schematic diagram of a gun-shaped charging coupler provided according to an embodiment of the present disclosure;

FIG. 3 is a flow diagram of a charging control method provided according to another embodiment of the present disclosure;

FIG. 4 is a structural block diagram of a charging control device provided according to an embodiment of the present disclosure;

FIG. 5 is a structural block diagram of a charging control device provided according to another embodiment of the present disclosure;

FIG. 6 is a structural block diagram of a charging system for an electric vehicle provided according to an embodiment of the present disclosure.

### DETAILED DESCRIPTION OF THE EMBODIMENTS

The embodiments of the present disclosure will be described in detail below in conjunction with the accompanying drawings. It should be understood that the embodiments described herein are merely intended for describing and explaining, rather than limiting, the present disclosure.

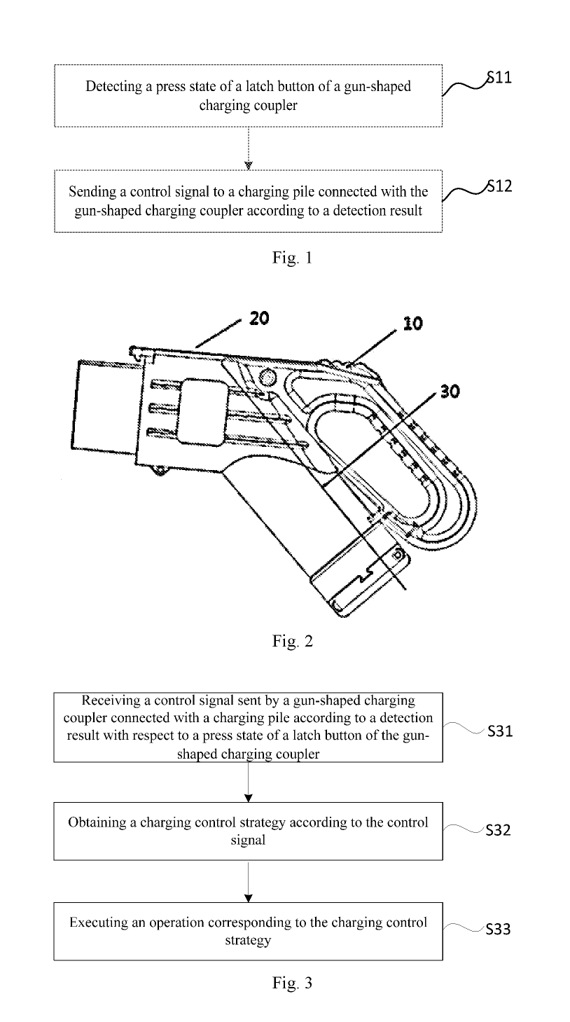

FIG. 1 is the flow chart of a charging control method provided according to an embodiment of the present disclosure, in which the charging control method may be applied to a gun-shaped charging coupler. As shown in FIG. 1, the charging control method may include the following steps.

In step S11, a press state of a latch button of the gun-shaped charging couple is detected. Specifically, the press state of the latch button may be determined, for example, by parameters such as the magnitude, duration, frequency and times of applying of the pressure on the latch button. The pressure of the latch button is a force exerted to the latch button by a user mutually pressing the latch button. The duration of the pressure is the duration when the user presses the latch button. The frequency of the pressure is the times of applying the pressure in unit time.

FIG. 2 is a schematic diagram of a gun-shaped charging coupler provided according to an embodiment of the present disclosure. As shown in FIG. 2, an action detecting device 10 may be disposed at the latch button of the gun-shaped charging coupler 20. Exemplarily, the action detecting device 10 may be a pressure sensor or a pressure switch. In this case, the gun-shaped charging coupler 20 may detect the pressure on the latch button of the gun-shaped charging coupler and the duration of the pressure thereon by means of the action detecting device 10.

Now referring back to FIG. 1, in step S12, a control signal is sent to a charging pile connected with the gun-shaped charging coupler according to a detection result, in which the control signal is used for allowing the charging pile to obtain a charging control strategy and controlling charging pile to execute an operation corresponding to the charging control strategy.

In the present disclosure, the operation of determining the charging control strategy can be carried out at the side of the gun-shaped charging coupler or the side of the charging pile. In the case of executing the operation at the side of the charging pile, the step S12 may include: sending a control signal including the detection result to the charging pile connected with the gun-shaped charging coupler, wherein the control signal is used for allowing the charging pile to obtain the charging control strategy according to the detection result.

Stated another way, in this embodiment, after a detection result with respect to the pressure is obtained, the gun-shaped charging coupler may make the detection result contained in a control signal and send the control signal to the charging pile. The charging pile may obtain the detection result from the control signal after receiving the control signal. Subsequently, the charging pile may determine a charging control strategy according to the detection result. An operation corresponding to the charging control strategy is then executed.

In an embodiment that the determination of a charging control strategy is completed by the gun-shaped charging coupler itself, the step S12 may include:

determining a charging control strategy according to a detection result; and

sending a control signal including the charging control strategy to the charging pile connected with the gun-shaped charging coupler.

That is to say, in this embodiment, after the gun-shaped charging coupler obtains a detection result with respect to the pressure, the gun-shaped charging coupler itself determines a charging control strategy according to the detection result. Subsequently, the gun-shaped charging coupler may make the charging control strategy contained in a control signal and send the control signal to the charging pile. The charging pile may obtain the charging control strategy from the control signal after receiving the control signal, and directly executes an operation corresponding to the charging control strategy.

Exemplarily, as shown in FIG. 2, the gun-shaped charging coupler 20 may complete signal transmission with the charging pile by means of, for example, a signal transmission wire 30.

In the present disclosure, whether the determination of a charging control strategy is achieved by the gun-shaped charging coupler itself or by the charging pile, the charging control strategy may be determined in the following way.

When the detection result indicates that the magnitude of the pressure on the latch button is greater than a preset first pressure threshold, and the duration of the pressure is longer than a first preset duration, the charging control strategy is determined as decreasing a charging current. Exemplarily, the first pressure threshold may be set to a minimum pressure value that can be detected by the action detecting device 10. In other embodiments, the first pressure threshold may also be set to other values.

Alternatively or additionally, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration.

In the present disclosure, the first preset duration and the second preset duration both can be set according to actual requirements, whereas the second preset duration is set to be longer than the first preset duration. Exemplarily, the first preset duration is 5 s, and the second preset duration is 10 s.

Alternatively or additionally, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery. Specifically, the control strategy of suspending charging may be, for example, waiting for being triggered for charging or automatic recharging after a predetermined duration. The control strategy of heating a battery may be, for example, controlling automatic triggering for charging after heating a battery to a predetermined temperature.

For instance, when detecting that the latch button is pressed (greater than the third pressure threshold) twice within 1 s, the charging control strategy is determined as suspending charging; or, when detecting that the latch button is pressed (greater than the third pressure threshold) three times within 1 s, the charging control strategy is determined as heating a battery.

In this way, a user can make different control requirements, for example, decreasing a charging current, stopping charging, suspending charging or heating a battery, by pressing the latch button of the gun-shaped charging coupler for different durations or at different time intervals. The gun-shaped charging coupler or the charging pile may determine corresponding charging control strategies according to the detection results of the pressure on the latch button, and may execute corresponding operations, thereby meeting the requirements of the user.

In addition, in the present disclosure, an electronic lock may be provided in the gun-shaped charging coupler. The electronic lock is configured for fastening the gun-shaped charging coupler to a vehicle charging base during charging, thus preventing separation of the gun-shaped charging coupler from the vehicle charging base during charging. Since the electronic lock is used to take the place of an existing mechanical lock, electrical control may be carried out on the electronic lock to control whether the gun-shaped charging coupler is allowed to be pulled out of the vehicle charging base.

In an optional embodiment of the present disclosure, the detection result is further used for determining an electronic lock control strategy for the electronic lock of the gun-shaped charging coupler. Specifically, the electronic lock control strategy may be used for indicating whether or not to allow unlocking of the electronic lock.

In one embodiment, the electronic lock control strategy may be determined by the gun-shaped charging coupler itself according to the detection result. Exemplarily, the gun-shaped charging coupler may determine the electronic lock control strategy as unlocking of the electronic lock when the detection result indicates that the magnitude of the pressure on the latch button is greater than the preset third pressure threshold, and the duration of the pressure is greater than a third preset duration. Subsequently, unlocking of the electronic lock in the gun-shaped charging coupler is triggered.

Alternatively, in another embodiment, the electronic lock control strategy may be determined by the charging pile according to the detection result. Exemplarily, as described above, the gun-shaped charging coupler may make the detection result contained in a control signal and send the control signal to the charging pile. In this case, the charging pile may also determine the electronic lock control strategy for the gun-shaped charging coupler according to the detection result. For example, the charging pile may determine the electronic lock control strategy as unlocking of the electronic lock when the detection result indicates that the magnitude of the pressure on the latch button is greater than the preset third pressure, and the duration of the pressure is greater than a third preset duration.

Subsequently, the charging pile may send the determined electronic lock control strategy to the gun-shaped charging coupler. After the gun-shaped charging coupler receives the electronic lock control strategy, if the electronic lock control strategy indicates unlocking of the electronic lock, the gun-shaped charging coupler triggers the unlocking of the electronic lock.

After the unlocking of the electronic lock, the gun-shaped charging coupler is allowed to be pulled out; or otherwise, the gun-shaped charging coupler is not allowed to be pulled out.

Thus, when the second preset duration is equal to the third preset duration, the second pressure threshold is equal to the third pressure threshold, and the duration of the pressure is longer than the third preset duration, automatic unlocking of the electronic lock may also be achieved to allow a user to pull out the gun-shaped charging coupler, in addition to automatically controlling stopping of the charging process. In this way, the risks caused by pulling out the gun-shaped charging coupler with load can be effectively avoided with guarantee on the service lives of the gun-shaped charging coupler and the vehicle charging outlet, protection on the safety of people, and improvement during charging of the electric vehicle.

FIG. 3 is a flow chart of a charging control method provided according to another embodiment of the present disclosure, in which the charging control method may be used for a charging pile. As shown in FIG. 3, the charging control method may comprise the following steps.

In step S31, a control signal sent by a gun-shaped charging coupler connected with the charging pile according to a detection result with respect to a press state of a latch button of the gun-shaped charging coupler is received.

In step S32, a charging control strategy is obtained according to the control signal.

In step S33, an operation corresponding to the charging control strategy is executed.

Optionally, the control signal may include a charging control strategy determined by the gun-shaped charging coupler according to the detection result.

Optionally, the control signal includes the detection result. In this case, the step S32 may include:

obtaining the detection result from the control signal; and

determining a charging control strategy according to the detection result.

Optionally, the step of determining a charging control strategy according to the detection result may include at least one of the following steps: determining the charging control strategy as decreasing a charging current when the detection result indicates that a magnitude of a pressure on the latch button is greater than a preset first pressure threshold, and a duration of the pressure is longer than a first preset duration; alternatively, determining the charging control strategy as stopping charging when the detection result indicates that the magnitude of the pressure is greater than a preset second pressure threshold, and the duration of the pressure is longer than a second preset duration, wherein the second preset duration is longer than the first preset duration; alternatively, determining the charging control strategy according to the times of applying the pressure as suspending charging or heating a battery when the detection result indicates that the magnitude of the pressure is greater than a preset third pressure threshold, and the frequency of the pressure is greater than a preset frequency threshold.

Optionally, the control signal may include a detection result. In this case, the method may further include: determining an electronic lock control strategy for the gun-shaped charging coupler according to the detection result, the electronic lock control strategy being used for indicating whether unlocking of an electronic lock is allowed; and sending the electronic lock control strategy to the gun-shaped charging coupler.

Optionally, the step of determining an electronic lock control strategy for the gun-shaped charging coupler according to the detection result may include: determining the electronic lock control strategy as unlocking of the electronic lock when the detection result indicates that the magnitude of the pressure on the latch button is greater than the preset third pressure threshold, and the duration of the pressure is greater than a third preset duration.

As the charging control method applied to the side of the charging pile corresponds to the charging control method applied to the side of the gun-shaped charging coupler described in conjunction with FIG. 1 with some steps already illustrated in detail in the descriptions in conjunction with FIG. 1, the details of the charging control method applied to the side of the charging pile are not redundantly described herein in the present disclosure, and may refer to the descriptions made in conjunction with FIG. 1.

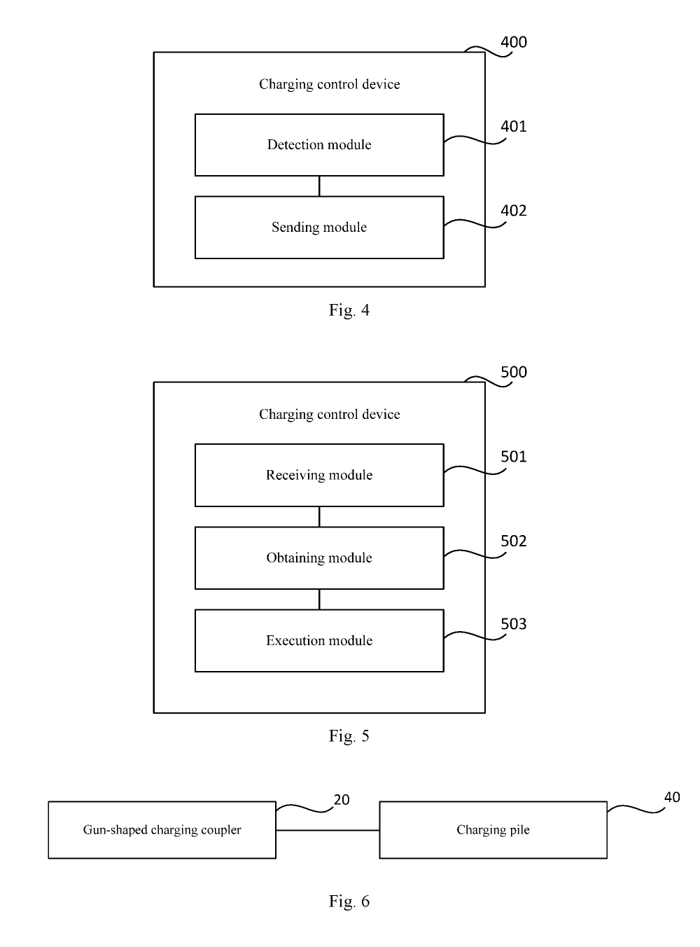

FIG. 4 is a structural block diagram of a charging control device 400 provided according to an embodiment of the present disclosure, in which the charging control device 400 may be disposed in the gun-shaped charging coupler. As shown in FIG. 4, the charging control device 400 may include a detection module 401 and a sending module 402.

The detection module 401 is configured to detect a press state of a latch button of the gun-shaped charging coupler.

The sending module 402 is configured to send a control signal to a charging pile connected with the gun-shaped charging coupler according to a detection result of the detection module 401, the control signal being used for allowing the charging pile to obtain a charging control strategy, and controlling the charging pile to execute an operation corresponding to the charging control strategy.

Optionally, the sending module 402 may include a first sending submodule.

The first sending submodule is configured to send a control signal including the detection result to the charging pile connected with the gun-shaped charging coupler, the control signal being used for allowing the charging pile to obtain the charging control strategy according to the detection result.

Optionally, the sending module 402 may include a first determination submodule and a second sending submodule.

The first determination submodule is configured to determine a charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.

The second sending submodule is configured to send a control signal including the charging control strategy to the charging pile connected with the gun-shaped charging coupler.

FIG. 5 is a structural block diagram of a charging control device 500 provided according to an embodiment of the present disclosure, in which the charging control device 500 may be disposed in a charging pile. As shown in FIG. 5, the charging control device 500 may include a receiving module 501, an obtaining module 502 and an execution module 503.

The receiving module 501 is configured to receive a control signal sent by a gun-shaped charging coupler connected with the charging pile according to a detection result with respect to a press state of a latch button of the gun-shaped charging coupler.

The obtaining module 502 is configured to obtain a charging control strategy according to the control signal.

The execution module 503 is configured to execute an operation corresponding to the charging control strategy.

Optionally, the control signal may include a charging control strategy determined by the gun-shaped charging coupler according to the detection result.

Optionally, the control signal may include the detection result. In this case, the obtaining module 502 may include an obtaining submodule and a second determination submodule.

The obtaining submodule is configured to obtain the detection result from the control signal.

The second determination submodule is configured to determine the charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.

With regard to the device in the above embodiment, the specific modes of executing operations by various modules have been already described in detail in the embodiment related to the method, and will not be described in detail herein.

FIG. 6 is a structural block diagram of a charing system for an electric vehicle provided according to an embodiment of the present disclosure. As shown in FIG. 6, the system may include a gun-shaped charging coupler 20 and a charging pile 40.

The gun-shaped charging coupler 20 is configured with the charging control device 400 provided according to the present disclosure.

The charging pile 40 is configured with the charging control device 500 provided according to the present disclosure.

In conclusion, the charging control method and device and the charging system for an electric vehicle provided by the present disclosure can realize protection control in the process of charging an electric vehicle. A user can control charging, such as decreasing the charging current or stopping charging, by pressing the latch button of the gun-shaped charging coupler. In this way, when charging needs to be stopped and a user forgets a charging card, charging can be ended by the user without pulling out the gun-shaped charging coupler, such that the risks caused by pulling out the gun-shaped charging coupler with load can be effectively avoided with guarantee on the service lives of the gun-shaped charging coupler and the vehicle charging outlet, protection on the safety of people, and improvement during charging of the electric vehicle.

The preferred embodiments of the present disclosure are described in detail above in conjunction with the accompanying drawings, whereas the present disclosure is not limited to the specific details in the above embodiments. Multiple simple modifications may be made to the technical solutions of the present disclosure within the scope of the technical conception of the present disclosure; and these simple modifications all fall into the protection scope of the present disclosure.

Additionally, it needs to be noted that various specific technical features described in the above embodiments may be combined in any appropriate way without contradiction. For the sake of avoiding needless repetition, various possible combination ways will not be described separately in the present disclosure.

In addition, various different embodiments of the present disclosure may also be combined arbitrarily and should be also considered as the contents disclosed in the present disclosure as long as they do not deviate from the concept of the present disclosure.

What is claimed is:

1. A charging control method, characterized by being applied to a gun-shaped charging coupler, the method comprising:
detecting a press state of a latch button of the gun-shaped charging coupler;
sending a control signal to a charging pile connected with the gun-shaped charging coupler according to a detection result, the control signal being used for allowing the charging pile to obtain a charging control strategy, and controlling the charging pile to execute an operation corresponding to the charging control strategy.

2. The method according to claim 1, characterized in that the step of sending a control signal to the charging pile connected with the gun-shaped charging coupler according to the detection result comprises:
sending a control signal including the detection result to the charging pile connected with the gun-shaped charging coupler, the control signal being used for allowing the charging pile to obtain the charging control strategy according to the detection result.

3. The method according to claim 2, characterized in that the control signal is further used for allowing the charging pile to determine an electronic lock control strategy for the gun-shaped charging coupler according to the detection result, the method further comprising:
receiving the electronic lock control strategy sent by the charging pile; and
triggering the unlocking of the electronic lock when the electronic lock control strategy indicates unlocking of an electronic lock.

4. The method according to claim 1, characterized in that the step of sending a control signal to the charging pile connected with the gun-shaped charging coupler according to the detection result comprises:
determining a charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery; and
sending a control signal including the charging control strategy to the charging pile connected with the gun-shaped charging coupler.

5. The method according to claim 1, characterized by further comprising:
triggering the unlocking of the electronic lock in the gun-shaped charging coupler when the detection result indicates that the magnitude of the pressure on the latch button is greater than the preset third pressure threshold, and the duration of the pressure is greater than a third preset duration.

6. A charging control method, characterized by being applied to a charging pile, the method comprising:
receiving a control signal sent by a gun-shaped charging coupler connected with the charging pile according to a detection result with respect to a press state of a latch button of the gun-shaped charging coupler;
obtaining a charging control strategy according to the control signal; and
executing an operation corresponding to the charging control strategy.

7. The method according to claim 6, characterized in that the control signal includes a charging control strategy determined according to the detection result;
or,
the control signal includes the detection result, and the step of obtaining a charging control strategy according to the control signal comprises:
obtaining the detection result from the control signal; and
determining the charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.

8. The method according to claim 6, characterized in that the control signal includes the detection result, the method further comprising:
determining an electronic lock control strategy for the gun-shaped charging coupler according to the detection result, the electronic lock control strategy being used for indicating whether unlocking of an electronic lock is allowed, wherein when the detection result indicates that the magnitude of the pressure on the latch button is greater than the preset third pressure threshold, and the duration of the pressure is greater than a third preset duration, the electronic lock control strategy is determined as unlocking of the electronic lock; and
sending the electronic lock control strategy to the gun-shaped charging coupler.

9. A charging control device, characterized by being disposed in a gun-shaped charging coupler, the device comprising:
a detection module configured to detect a press state of a latch button of the gun-shaped charging coupler;
a sending module configured to send a control signal to a charging pile connected with the gun-shaped charging coupler according to a detection result from the detection module, the control signal being used for allowing the charging pile to obtain a charging control strategy, and controlling the charging pile to execute an operation corresponding to the charging control strategy.

10. The device according to claim 9, characterized in that the sending module comprises:
a first sending submodule configured to send a control signal including the detection result to the charging pile connected with the gun-shaped charging coupler, the control signal being used for allowing the charging pile to obtain the charging control strategy according to the detection result;
or,
the sending module comprises:
a first determination submodule configured to determine a charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery;
a second sending submodule configured to send a control signal including the charging control strategy to the charging pile connected with the gun-shaped charging coupler.

11. A charging control device, characterized by being disposed in a charging pile, the device comprising:
a receiving module configured to receive a control signal sent by a gun-shaped charging coupler connected with the charging pile according to a detection result with respect to a press state of a latch button of the gun-shaped charging coupler;
an obtaining module configured to obtain a charging control strategy according to the control signal; and
an execution module configured to execute an operation corresponding to the charging control strategy.

12. The device according to claim 11, characterized in that the control signal includes a charging control strategy determined according to the detection result;
or,
the control signal includes the detection result, and the obtaining module comprises:
an obtaining submodule configured to obtain the detection result from the control signal;
a second determination submodule configured to determine the charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.

13. A charging system for an electric vehicle, characterized by comprising:
a gun-shaped charging coupler configured with a first charging control device, the first charging control device comprising:
a detection module configured to detect a press state of a latch button of the gun-shaped charging coupler;
a sending module configured to send a control signal to a charging pile connected with the gun-shaped charging coupler according to a detection result from the detection module, the control signal being used for allowing the charging pile to obtain a charging control strategy, and controlling the charging pile to execute an operation corresponding to the charging control strategy;
a charging pile configured with a second charging control device, the second charging control device comprising:
a receiving module configured to receive a control signal sent by a gun-shaped charging coupler connected with the charging pile according to a detection result with respect to a press state of a latch button of the gun-shaped charging coupler;
an obtaining module configured to obtain a charging control strategy according to the control signal; and
an execution module configured to execute an operation corresponding to the charging control strategy.

14. The system according to claim 13, characterized in that the sending module comprises:
a first sending submodule configured to send a control signal including the detection result to the charging pile connected with the gun-shaped charging coupler, the control signal being used for allowing the charging pile to obtain the charging control strategy according to the detection result;
or,
the sending module comprises:
a first determination submodule configured to determine a charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery;
a second sending submodule configured to send a control signal including the charging control strategy to the charging pile connected with the gun-shaped charging coupler.

15. The system according to claim 13, characterized in that the control signal includes a charging control strategy determined according to the detection result;
or,
the control signal includes the detection result, and the obtaining module comprises:
an obtaining submodule configured to obtain the detection result from the control signal;
a second determination submodule configured to determine the charging control strategy according to the detection result, wherein when the detection result indicates that a magnitude of a pressure on the latch button is greater than a preset first pressure threshold, and a duration of the pressure is longer than a first preset duration, the charging control strategy is determined as decreasing a charging current; alternatively, when the detection result indicates that the magnitude of the pressure is greater than a preset second pressure threshold, and the duration of the pressure is longer than a second preset duration, the charging control strategy is determined as stopping charging, wherein the second preset duration is longer than the first preset duration; alternatively, when the detection result indicates that the magnitude of the pressure is greater than a preset third pressure threshold, and the frequency of the pressure is greater than a preset frequency threshold, the charging control strategy is determined according to times of applying the pressure as suspending charging or heating a battery.
